(19) United States
(12) Patent Application Publication
(10) Pub. No.: US 2008/0045319 A1
(43) Pub. Date: Feb. 21, 2008

(54) Slot machine and playing method thereof

(75) Inventor: Hiroki Saito, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 11/882,192

(22) Filed: Jul. 31, 2007

(30) Foreign Application Priority Data
Aug. 18, 2006 (JP) JP2006-223227

(51) Int. Cl. A63F 9/24; A63F 13/00; A63F 13/02

(52) U.S. Cl. 463/20; 463/26; 463/31

(57) ABSTRACT

In a slot machine, a plural symbols having been displayed in each of matrix display areas on an LCD are firstly slid longitudinally and transversely when rearranging the plurality of symbols. Then, the symbols are newly rearranged in display areas 28 which have become blanked after the slide of the symbols. As a result, a payout is provided to a player if a winning combination is achieved. The slot machine can provide the player with a stronger feeling of expectation for a payout.

### CROSS-REFERENCE TO RELATED APPLICATION

This application is based upon the prior Japanese Patent Application No. 2006-223227, filed on Aug. 18, 2006, the entire contents of which are incorporated herein by reference.

### BACKGROUND OF THE INVENTION

1. Field of the Invention

The present invention relates to a slot machine with which a player plays a game and, more particularly, to a technical feature to display symbols in an innovative style on display areas.

2. Description of the Related Art

A conventional slot machine comprises a plurality of display areas provided in a matrix form. A payline is provided on the plurality of display areas. In general, a payline is provided as a straight line passing through the plurality of display areas transversely or obliquely. However, a slot machine having various paylines, which are not straight lines, has been proposed. Furthermore, a slot machine, which does not employ the concept of a payline, has been also proposed. For example, these types of slot machines are disclosed in U.S. Pat. No. 6,093,102 and U.S. Pat. No. 6,960,133.

With the above-described slot machine, however, a payout is provided to a player when a prescribed number of symbols are displayed in the plurality of display areas provided in a matrix form. In fact, the above-described slot machine also has substantially the same display style as that of the conventional slot machine.

Consequently, an object of the present invention is to provide a slot machine that can produce a sense of expectancy for a payout more strongly.

### SUMMARY OF THE INVENTION

A first aspect of the present invention provides a slot machine which comprises: a display which has a plurality of display areas in a plural rows by plural columns matrix, and on which symbols are arranged and rearranged in each of the display areas in each unit game; and a controller. The controller is operable to: (a) move the symbols, which have been displayed in the display areas except for at least one row and at least one column among the plurality of display areas, into other display areas after a unit game is started and hold the moved symbols in the other display areas; (b) rearrange the symbols in each of the display areas, in which the moved symbols are not held; and (c) provide a payout to a player (i) when a specific combination is achieved with the moved symbols and the rearranged symbols or (ii) when a prescribed number of specific symbols are displayed among the moved symbols and the rearranged symbols.

A second aspect of the present invention provides a slot machine which comprises: a display which has a plurality of display areas in a plural rows by plural columns matrix, and on which symbols are arranged and rearranged in each of the display areas in each unit game; and a controller. The controller is operable to: (a) move the symbols, which have been displayed in the display areas except for at least one row and at least one column among the plurality of display areas, into other display areas after a unit game is started and hold the moved symbols in the other display areas; (b) rearrange the symbols in each of the display areas, in which the moved symbols are not held; and (c) provide a payout to a player (i) when a specific combination is achieved with the moved symbols and the rearranged symbols or (ii) when a prescribed number of specific symbols are displayed among the moved symbols and the rearranged symbols. And, (i) the greater the number of symbols constituting the specific combination or (ii) the greater the number of the specific symbols, the more payout amount is provided to the player.

A third aspect of the present invention provides a slot machine which comprises: a display which has a plurality of display areas in a plural rows by plural columns matrix, and on which symbols are arranged and rearranged in each of the display areas in each unit game; and a controller. The controller is operable to: (a) move the symbols, which have been displayed in the display areas except for one outer-most row and one outer-most column among the plurality of display areas, into other display areas after a unit game is started and hold the moved symbols in the other display areas; (b) rearrange the symbols in each of the display areas, in which the moved symbols are not held; and (c) provide a payout to a player (i) when a specific combination is achieved with the moved symbols and the rearranged symbols or (ii) when a prescribed number of specific symbols are displayed among the moved symbols and the rearranged symbols.

A fourth aspect of the present invention provides a playing method of a slot machine having a display which has a plurality of display areas in a plural rows by plural columns matrix. The playing method comprises: moving symbols, which have been displayed after a previous unit game in the display areas except for at least one row and at least one column among the plurality of display areas, into other display areas after a current unit game is started and holding the moved symbols in the other display areas; rearranging symbols in each of the display areas, in which the moved symbols are not held; and providing a payout to a player (i) when a specific combination is achieved with the moved symbols and the rearranged symbols or (ii) when a prescribed number of specific symbols are displayed among the moved symbols and the rearranged symbols.

A fifth aspect of the present invention provides a playing method of a slot machine having a display which has a plurality of display areas in a plural rows by plural columns matrix. The playing method comprises: moving symbols, which have been displayed after a previous unit game in the display areas except for at least one row and at least one column among the plurality of display areas, into other display areas after a current unit game is started and holding the moved symbols in the other display areas; rearranging symbols in each of the display areas, in which the moved symbols are not held; and providing a payout to a player (i) when a specific combination is achieved with the moved symbols and the rearranged symbols or (ii) when a prescribed number of specific symbols are displayed among the moved symbols and the rearranged symbols. And, (i) the greater the number of symbols constituting the specific combination or (ii) the greater the number of the specific symbols, the more payout amount is provided to the player.

A sixth aspect of the present invention provides a playing method of a slot machine having a display which has a plurality of display areas in a plural rows by plural columns matrix. The playing method comprises: moving symbols, which have been displayed after a previous unit game in the display areas except for at least one row and at least one column among the plurality of display areas, into other display areas after a current unit game is started and holding the moved symbols in the other display areas; rearranging symbols in each of the display areas, in which the moved symbols are not held; displaying an image for drawing the player's attention respectively near (i) the symbols constituting the specific combination or (ii) the prescribed number of specific symbols; and providing a payout to a player (i) when a specific combination is achieved with the moved symbols and the rearranged symbols or (ii) when a prescribed number of specific symbols are displayed among the moved symbols and the rearranged symbols.

### BRIEF DESCRIPTION OF THE DRAWINGS

FIG. 1 is a flow chart showing the operation of a playing method of a slot machine in an embodiment of the present invention.

FIG. 2 is a perspective view showing an outside appearance of the slot machine in an embodiment of the present invention.

FIG. 3 is an explanatory diagram showing symbols displayed in each display area of the slot machine in an embodiment of the present invention.

FIG. 4 is an explanatory diagram showing winning combinations accompanied by payout and their payout amounts of the slot machine in an embodiment of the present invention.

FIG. 5 is a block diagram showing a control circuit of the slot machine in an embodiment of the present invention.

FIG. 6 is a flow chart showing the procedure of authentication processing of the slot machine in an embodiment of the present invention.

FIG. 7 is a flow chart showing the procedure of execution processing of a base game of the slot machine in an embodiment of the present invention.

FIG. 8 is a flow chart showing the procedure of stop symbol determination processing of the slot machine in an embodiment of the present invention.

FIG. 9 is a flow chart showing the procedure of scroll control processing of symbols of the slot machine in an embodiment of the present invention.

FIG. 10 is an explanatory diagram showing symbols displayed before a base game is started in the slot machine in an embodiment of the present invention.

FIG. 11 is an explanatory diagram showing symbols scrolled and displayed after the base game is started in the slot machine in an embodiment of the present invention.

FIG. 12 is an explanatory diagram showing a screen when a winning combination of three “diamond” symbols has stopped in the slot machine in an embodiment of the present invention.

FIG. 13 is an explanatory diagram showing a screen when a winning combination of four “diamond” symbols has stopped in the slot machine in an embodiment of the present invention.

FIG. 14 is an explanatory diagram showing display areas of five columns and five rows of the slot machine in an embodiment of the present invention.

### DETAILED DESCRIPTION OF THE EMBODIMENT

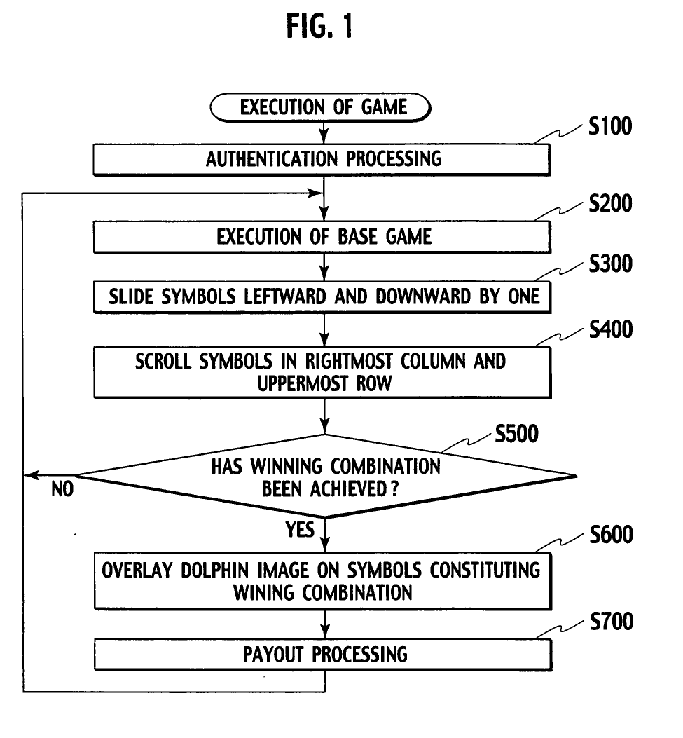

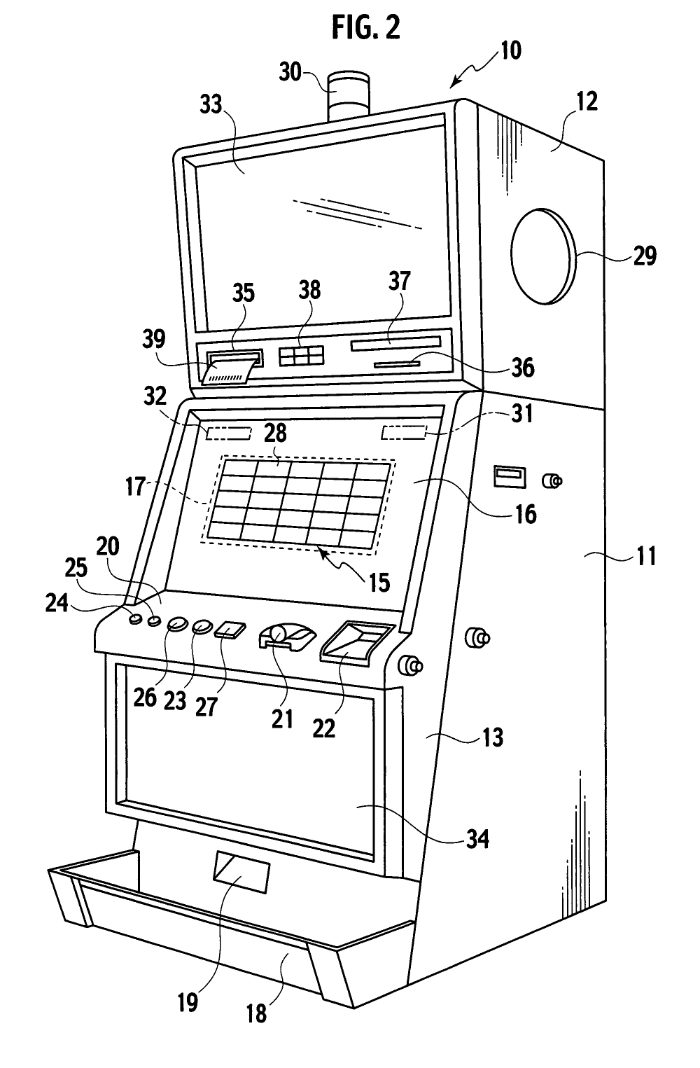

Embodiments of the present invention will be described below with reference to the drawings. FIG. 1 is a flow chart schematically showing a playing method of a slot machine of the present invention. The schematic operation of the slot machine and the playing method of the present invention will be described below with reference to the flow chart shown in FIG. 1 and a perspective view shown in FIG. 2.

In the slot machine of the present embodiment, authentication processing is firstly executed after power-on activation (step S100). In the authentication processing, initial checking processing is executed prior to starting a base game, in order to check whether or not programs for operating system run properly, and whether or not there is any alteration of programs, etc.

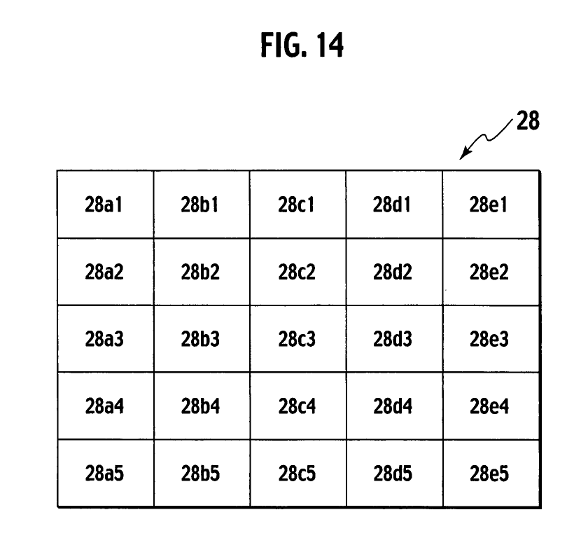

Next, the base game is executed (step S200). A display window 15 is provided on the front of a cabinet 11. A liquid crystal display (LCD) 17 is installed inside the display window 15. Symbol is displayed (arranged) on each of display areas 28 (28a1 to 28e5) of the display window 15. The total twenty-five display areas 28 are provided in 5 columns×5 rows. Suffixes “a” to “e” of the display areas 28 indicate columns, and suffixes “1” to “5” indicate rows (refer to FIG. 14).

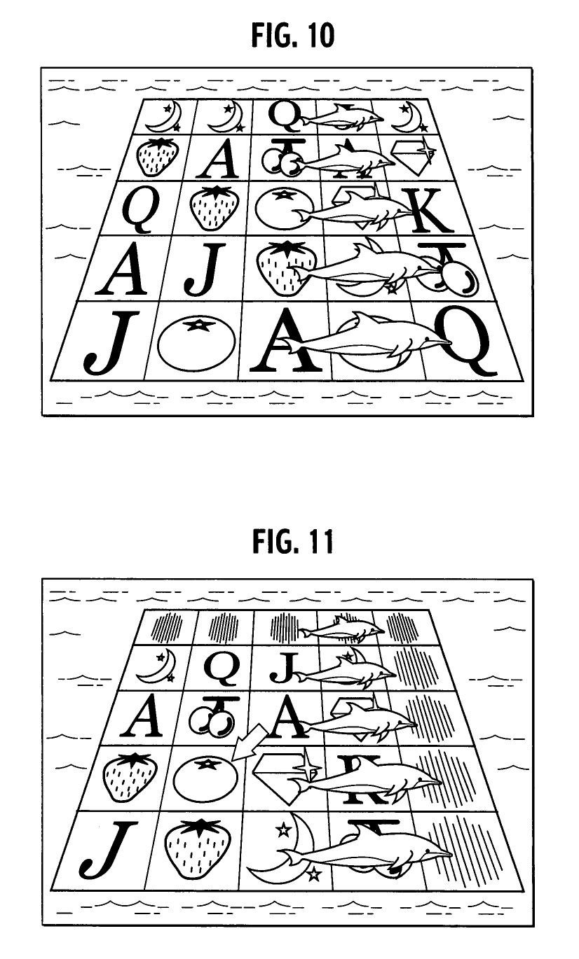

In the base game, the symbol displayed in each of the display areas 28 (28a1 to 28e5) is slid leftward and downward by one, when a spin button 23 is pressed after a bet of a desired credit by inserting coin(s) into a coin insertion slot 21 (step S300). That is, the symbols displayed in the leftmost column (in the display areas 28a1 to 28a5) and the symbols displayed in the lowermost row (in the display areas 28a5 to 28e5) are deleted, and the symbols displayed in the remaining 4×4 display areas 28 are slid leftward and downward (refer to FIGS. 10 and 11).

Then, the symbols are scrolled in each of the nine blanked display areas 28 (the display areas 28e1 to 28e5 in the rightmost column and the display areas 28a1 to 28e1 in the uppermost row) after the above-mentioned slide (step S400). Subsequently, the symbols are stopped (refer to FIGS. 11 and 12).

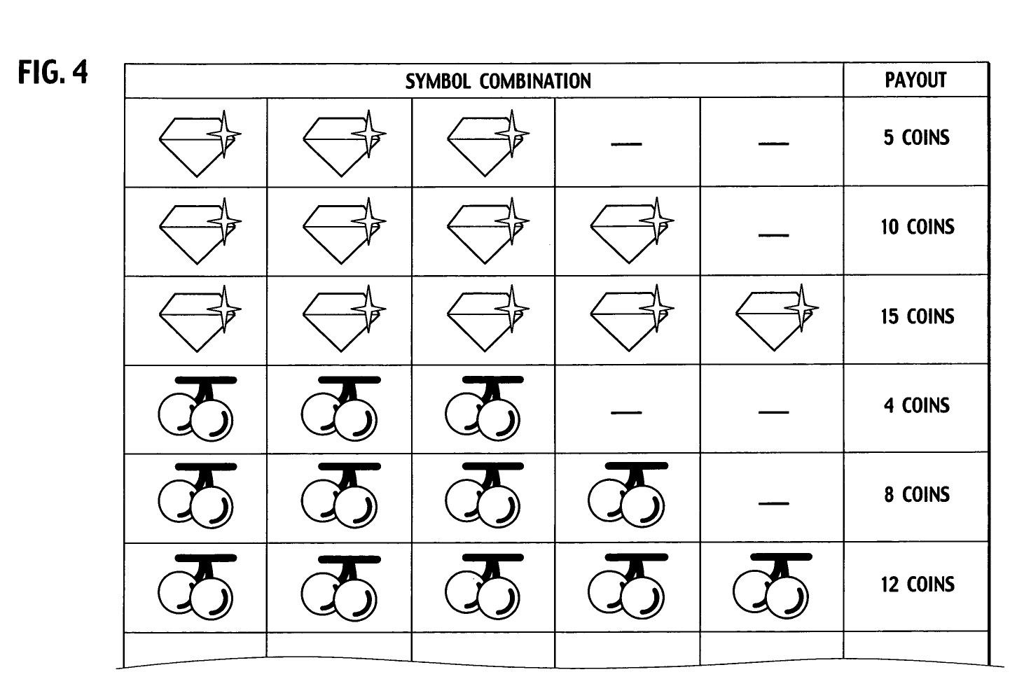

Upon the completion of step 400, it is determined whether or not a winning combination has been achieved based on the symbols displayed in the 5×5 display areas 28 (step S500). A winning combination is a symbol combination for awarding payout. For example, a payout of five coins is awarded when three successive “diamond” symbols have stopped on a straight line (refer to FIG. 4).

When a winning combination has been achieved (YES in step 500), an image for drawing player's attention (attention-grabber image: for example, a dolphin image shown in FIG. 12) is overlaid on each symbol constituting the winning combination (step S600). Then, payout processing is executed according to the winning combination (step S700).

In the above-described example, the 5×5 display areas 28 are slid leftward and downward by one in each base game. However, they may be slid rightward and upward. In addition, the number of columns or rows to be slid is not limited to one. They may be slid by two or more columns and rows. Furthermore, the number of columns or rows to be slid may differ in each base game.

In the above-described example, the attention-grabber image is a “dolphin” image. However, another image may be displayed as an attention-grabber image.

Next, the configuration of a slot machine 10 in an embodiment of the present invention will be described with reference to the perspective view shown in FIG. 2. The slot machine 10 is installed in a gaming facility.

In the slot machine 10, coins, bills, and electronic value information equivalent thereto are used as game media for playing a unit game. However, a game medium of the present invention is not limited in particular. For example, medals, tokens, electronic money and tickets may be used as game media. The above-mentioned ticket is not limited in particular. For example, an after-mentioned bar code ticket 39 is used.

As shown in FIG. 2, the slot machine 10 comprises the cabinet 11 and a top box 12 installed on the cabinet 11. A main door 13 is provided on the front of the cabinet 11.

Within the cabinet 11, the LCD (display) 17 is provided behind the display window 15 made of a transparent material. A plurality of symbols is scrolled on the LCD 17. The LCD 17 has the display areas 28 (28a1 to 28e5; refer to FIG. 14) for displaying symbols in five columns and five rows. Consequently, a player can visually recognize the symbols in the display areas 28 through the display window 15. When the base game is executed, symbols in the display areas 28 (28a1 to 28e5) are slid leftward and downward by one. And, in the display areas 28 in the rightmost column and the uppermost row (in the nine display areas 28e1 to 28e5, 28a1 to 28e1), the scroll of symbols is started.

In the present embodiment, the 5 columns×5 rows display areas 28 (28a1 to 28e5) of the LCD 17 constitute a “display”. However, the display of the present invention is not limited to this.

A lower display panel 16 is provided on the front of the main door 13. The lower display panel 16 comprises a transmissive LCD. Various information, effect images, etc., relating to a game are displayed on the lower display panel 16 during the game.

The lower display panel 16 has a credit counter 31 and a payout counter 32. The number of credited coins is displayed on the credit counter 31. The number of coins to be paid out according to a winning combination is displayed on the payout counter 32.

For example, a winning combination is a combination in which three identical symbols are arranged successively on a straight line. When such a winning combination is arranged in the display areas 28, prescribed coins are provided to the player as a payout. The number of coins to be paid out increases as the number of bets increases. For example, in case where five coins will be paid out per one bet, ten coins will be provided to the player as a payout for two bets.

The lower display panel 16 has the above-mentioned display window 15. The player can visually recognize the symbols displayed in the 5 columns×5 rows display areas 28 (28a1 to 28e5) of the LCD 17 installed behind the lower display panel 16.

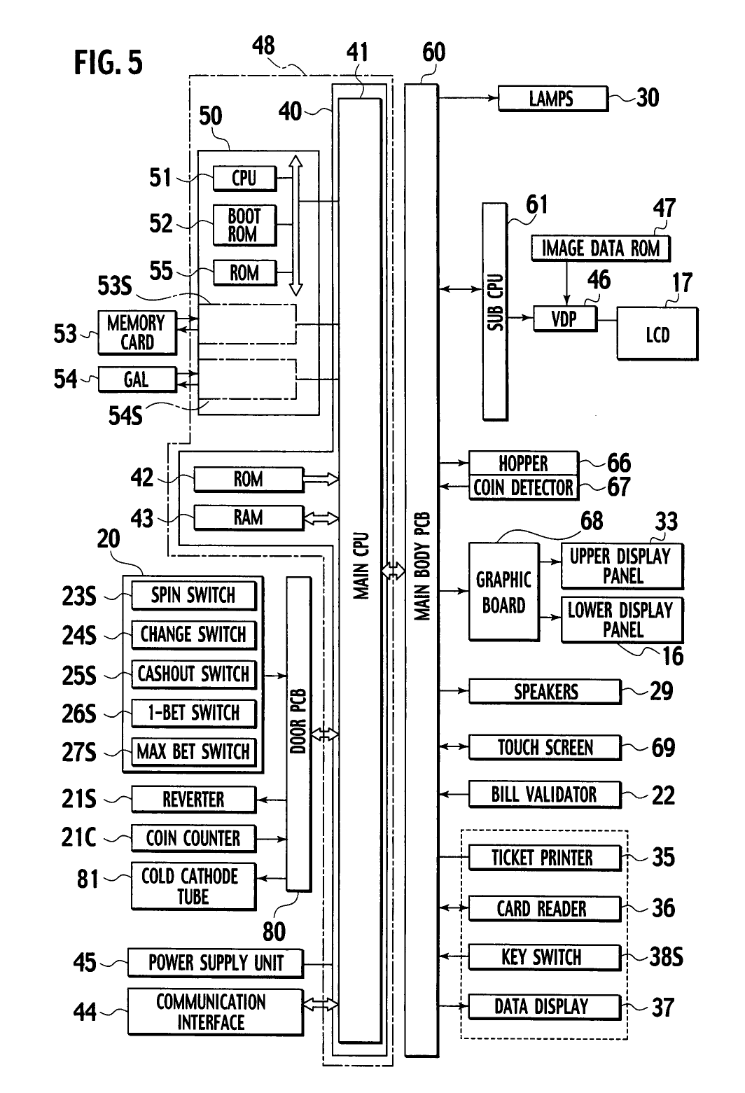

Further, a touch screen 69 (refer to FIG. 5) is provided on the front surface of the lower display panel 16. The player can input various directions by operating the touch screen 69.

A control panel 20, the coin insertion slot 21 for accepting coins into the cabinet 11, and a bill validator 22 are provided below the lower display panel 16. The control panel 20 has plural buttons 23 to 27, through which the player can input directions relating to the game progress.

The control panel 20 includes the spin button 23, a change button 24, a cashout button 25, a 1-bet button 26, and a max-bet button 27. The spin button 23 is a button to start the scroll of the symbols displayed in the display areas 28. The change button 24 is a button to request a staff in the gaming facility for exchange. The cashout button 25 is a button to cash out credited coins onto a coin tray 18.

The 1-bet button 26 is a button to bet one credit (coin) on the game. The max-bet button 27 is a button to bet the maximum number of credits (coins) that can be bet on a single game (for example, 50 credits).

The bill validator 22 validates whether or not the inserted bill is legitimate, and accepts the legitimate bill into the cabinet 11. In addition, the bill validator 22 may also read the after-mentioned bar code ticket 39. A decorative panel 34, on which the character of the slot machine 10 etc. is drawn, is provided on the lower front of the main door 13 (that is, below the control panel 20).

An upper display panel 33 is provided on the front of the top box 12. The upper display panel 33 comprises an LCD. For example, effect images, introduction of the content of the game, and the game rules are displayed on the upper display panel 33.

The top box 12 is provided with speakers 29 for audio output. A ticket printer 35, a card reader 36, a data display 37, and a keypad 38 are provided below the upper display panel 33. The ticket printer 35 prints out the bar code ticket 39. Data of the credit, the date, the identification number of the slot machine 10, etc. has been encoded into bar code and printed on the bar code ticket 39. The player can play games with another slot machine using the bar code ticket 39 and exchange the bar code ticket 39 with bills etc. at a cashier in the gaming facility.

The card reader 36 reads data from a smart card and writes data into the same. The smart card is carried by a player. For example, identification data of the player and the game history data are stored in the smart card.

The data display 37 is constituted by a fluorescent display and soon. For example, the data read by the card reader 36 and the data input by the player through the keypad 38 are displayed on the data display 37. Directions and data relating to ticket issuance are input through the keypad 38.

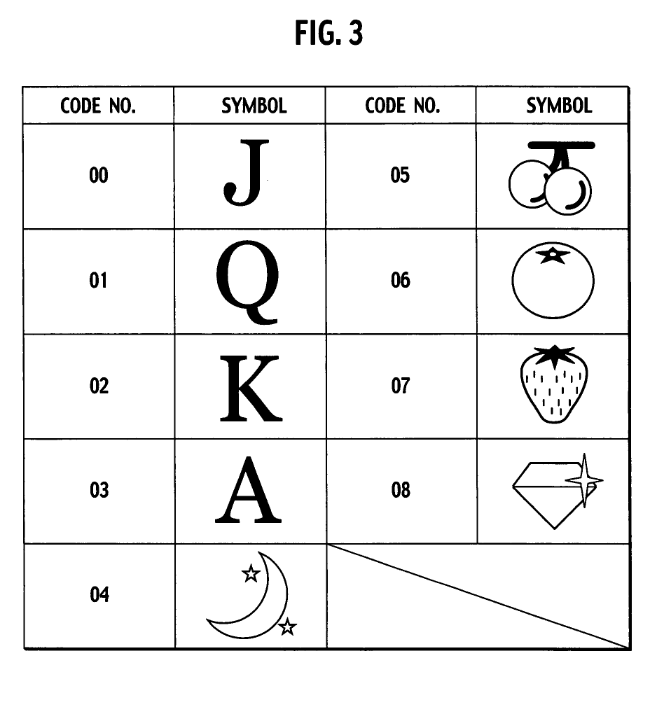

FIG. 3 is an explanatory diagram showing the symbols to be scrolled in each of the display areas 28 of the LCD 17 installed in the cabinet 11. As shown in FIG. 3, a total of nine kinds of symbols are specified with code numbers “00” to “08”. These symbols are scrolled randomly regardless of the code number order.

The symbols “J”, “A”, “moon”, “cherry”, “orange”, “strawberry”, and “diamond” are specified. Then, winning combinations awarding a payout are defined by the combination of the above-mentioned symbols. In addition, a payout table is specified to define payouts according to the winning combinations.

FIG. 4 is a diagram showing the payout table. The payout table specifies the payout amount per one bet in accordance with the number of identical symbols successively arranged on a straight line. For example, if the three “diamond” symbols are successively arranged on a straight line, a payout equivalent to five coins is awarded per one bet. The payout is awarded when the symbols are arranged transversely, longitudinally, or obliquely.

FIG. 5 is a block diagram showing the control circuit of the slot machine 10 in FIG. 2. As shown in FIG. 5, the control circuit comprises a controller 48, a main PCB (Printed Circuit Board) 60, a sub CPU (Central Processing Unit) 61, a door PCB 80, and components such as various switches, sensors, etc. In addition, the controller 48 comprises a motherboard 40 and a gaming board 50.

The gaming board 50 includes a CPU 51, a ROM (Read Only Memory) 55, a boot ROM 52, a card slot 53S corresponding to a memory card 53, and an IC socket 54S corresponding to a GAL (Generic Array Logic) 54. These components are connected to one another by internal buses.

Game programs and game system programs are stored in the memory card 53. The game programs include a stop symbol determination program. The stop symbol determination program is a program for determining symbols (code numbers corresponding to symbols) to be stopped in each of the display areas 28 (28a1 to 28e5). The stop symbol determination program includes weighting data corresponding to each of a variety of the payout rates (for example, 80%, 84%, 88%). The weighting data is data showing a correspondence relationship between the code number of each symbol (refer to FIG. 3) and at least one random number within a prescribed range (0 to 255) in relation to each of the display areas 28 (28a to 28e).

The payout rate is determined based on payout rate setting data output from the GAL 54. The symbols to be stopped are determined based on the weighting data of the determined payout rate.

The card slot 53S is configured to be capable of inserting therein and removing therefrom the memory card 53. In addition, the card slot is connected to the motherboard 40 via an IDE bus. Consequently, by removing the memory card 53 from the card slot 53S, writing another game program and game system program to the memory card 53, and reinserting the memory card 53 into the card slot 53S, it is possible to change the kinds and contents of the game played with the slot machine 10.

The game program includes a game progress program and a transition program to a bonus game. In addition, the game program includes image data and audio data, which are output during the game. The image data includes an image (dolphin image) for drawing player's attention to a winning combination.

The GAL 54 includes a plurality of input ports and output ports. Data is input to an input port, and then data corresponding to the input data is output from the output port. The data output from the output port is the above-described payout rate setting data.

The IC socket 54S is configured to be capable of attaching thereto and removing therefrom the GAL 54. In addition, the IC socket 54S is connected to the motherboard 40 via a PCI bus. Consequently, by removing the GAL 54 from the IC socket 54S, rewriting the program stored in the GAL 54, and reattaching the GAL 54 to the IC socket 54S, it is possible to change the payout rate setting data output from the GAL 54.

The CPU 51, the ROM 55, and the boot ROM 52 connected to one another by the internal buses are connected to the motherboard 40 via the PCI bus. The PCI bus transmits signals between the motherboard 40 and the gaming board 50, and supplies electric power from the motherboard 40 to the gaming board 50. Country identification information and an authentication program are stored in the ROM 55. A preliminary authentication program, boot code, etc., are stored in the boot ROM 52. The boot code is a program for activating the preliminary authentication program by the CPU 51.

The authentication program is a program for certifying the game program and the game system program (falsification check program). The authentication program is a program for checking and proving that the game program and the game system program have not been falsified. In other words, the authentication program is written in accordance with the certifying procedure of the game program and the game system program. The preliminary authentication program is a program for certifying the above-described authentication program. The preliminary authentication program is written in accordance with the procedure for certifying the authenticating program (the procedure to prove that the authentication program, which is subjected to the authentication processing, has not been falsified).

The motherboard 40 includes a main CPU 41, a ROM 42, a RAM (Random Access Memory) 43, and a communication interface 44. The main CPU 41 wholly controls the slot machine 10. In particular, the main CPU 41 executes the following controls (i) to (iv) when the spin button 23 is pressed after credits have been bet; (i) outputting a command signal, to slide symbols in the display areas 28 (28a1 to 28e5) leftward and downward by one, to the sub CPU 61, (ii) outputting a command signal, to scroll the symbols in each of the display areas 28 in the rightmost column (the display areas 28e1 to 28e5) and the uppermost row (28a1 to 28e1), to the sub CPU 61, (iii) determining the stop symbols in each of the display areas 28 in the rightmost column and the uppermost row, and (iv) stopping the determined symbols in each of the display areas 28.

In other words, the controller 48 is equipped with a function of sliding the symbols on the display areas 28 longitudinally and transversely and rearranging symbols in the blanked display areas 28 after the slide of the symbols, when rearranging the symbols arranged in the display areas 28 on the display (LCD 17).

Further, when three or more identical symbols have stopped successively on a straight line in the display areas 28 (28a1 to 28e5), the controller 48 determines a payout amount with reference to the payout table in FIG. 4. At this time, as the number of successive symbols increases ( . . . , four, five), the more payout amount is determined. In other words, the main CPU 41 is equipped with a function of providing a prescribed payout to the player when a prescribed number of identical symbols (for example, three identical symbols) are rearranged successively on a straight line, and awarding the more payout amount as the number of successive identical symbols increases beyond the above-mentioned prescribed number.

The ROM 42 stores programs, such as a BIOS (Basic Input/Output System) executed by the main CPU 41, and data used permanently. When the BIOS is executed by the main CPU 41, the initialization processing of peripheral devices is executed and read processing of the game program and the game system program stored in the memory card 53 via the gaming board 50 is started.

The RAM 43 stores data and programs used during the execution of processing by the main CPU 41.

The slot machine 10 communicates with the host computer etc. in the gaming facility via a signal communication line using the communication interface 44.

In addition, the main PCB 60 and the door PCB 80 are connected to the motherboard 40 via a USB (Universal Serial Bus). Further, a power supply unit 45 is connected to the motherboard 40. When electric power is supplied from the power supply unit 45 to the motherboard 40, the main CPU 41 on the motherboard 40 is activated. Furthermore, when electric power is supplied to the gaming board 50 via the PCI bus, the CPU 51 on the gaming board 50 is activated.

A device to generate an input signal to the main CPU 41 and a device to be controlled by a control signal from the main CPU 41 are connected to the main CPU 60 and the door PCB 80. The main CPU 41 executes the game program and the game system program stored in the RAM 43 based on the input signal. Then, the main CPU 41 stores the result of the operation processing in the RAM 43 and executes processing to send the control signal to each device as control processing of each device.

Lamps 30, the sub CPU 61, a hopper 66, a coin detector 67, a graphic board 68, the speakers 29, the touch screen 69, the bill validator 22, the ticket printer 35, the card reader 36, a key switch 38S, and the data display 37 are connected to the main PCB 60.

The sub CPU 61 slides the 25 symbols displayed in the display areas 28 (28a1 to 28e5) on the LCD 17 leftward and downward by one based on the command from the main CPU 41. In addition, the sub CPU 61 scrolls the symbols in each of the display areas 28 (28e1 to 28e5, 28a1 to 28e1) in the rightmost column and the uppermost row based on the command from the main CPU 41. Further, the sub CPU 61 is connected with a VDP (Video Display Processor) 46.

The VDP 46 reads image data of the symbols stored in an image data ROM 47 by the control of the sub CPU 61. Then, the VDP 46 generates a scroll image to be displayed on the LCD 17 from the read image data, and outputs the scroll image to the LCD 17. In addition, the VDP 46 reads the attention-grabber image (for example, a dolphin image) stored in the image data ROM 47 by the control of the sub CPU 61, and overlays the dolphin image on each symbol constituting the winning combination in order to notify the player that the winning combination has been achieved.

In other words, the sub CPU 61 is equipped with a function of overlaying the image for drawing the player's attention on a prescribed number of identical symbols when the prescribed number of identical symbols is rearranged successively on a straight line.

The hopper 66 is installed within the cabinet 11, and cashes out a prescribed number of coins from a coin payout opening 19 onto the coin tray 18 based on a control signal from the main CPU 41. The coin detector 67 is installed inside the coin payout opening 19, and outputs a signal to the main CPU 41 when detecting that a prescribed number of coins have been cashed out from the coin payout opening 19.

The graphic board 68 controls image display processing (other than the image display processing of the symbols in the display areas 28) on the upper display panel 33 and the lower display panel 16 based on the control signal from the main CPU 41. On the credit counter 31 of the lower display panel 16, credits stored in the RAM 43 are displayed. On the payout counter 32 on the lower display panel 16, the number of coins for payout is displayed. In addition, the graphic board 68 includes the VDP for generating image data based on the control signal from the main CPU 41, the video RAM for temporarily storing generated image data, and so on.

The bill validator 22 reads the image of the bill and accepts legitimate bills into the inside of the cabinet 11. In addition, when accepting the legitimate bill, the bill validator 22 outputs a signal about the amount of the bill to the main CPU 41. The main CPU 41 stores credits corresponding to the amount of the bill in the RAM 43 based on the signal.

The ticket printer 35 prints out the bar code ticket 39 that has bar-coded information (the data of the credits stored in the RAM 43, the date, the identification number of the slot machine 10, and so on).

The card reader 36 reads the data of the smart card and transmits it to the main CPU 41, and writes data to the smart card based on the control signal from the main CPU 41. The key switch 38S is provided to the keypad 38 and outputs a signal to the main CPU 41 during the player's operation of the keypad 38.

The data display 37 displays the data read by the card reader 36 and the data input by a player via the keypad 38 based on the control signal from the main CPU 41.

The control panel 20, a reverter 21S, a coin counter 21C, and a cold cathode tube 81 are connected to the door PCB 80. The control panel 20 is provided with a spin switch 23S corresponding to the spin button 23, a change switch 24S corresponding to the change button 24, a cashout switch 25S corresponding to the cashout button 25, a 1-bet switch 26S corresponding to the 1-bet button 26, and a max-bet switch 27S corresponding to the max-bet button 27. Each of the switches 23S to 27S outputs a signal to the main CPU 41 when a player operates its corresponding one of the buttons 23 to 27.

The coin counter 21C is provided inside the coin insertion slot 21 and validates whether or not the coin inserted through the coin insertion slot 21 is legitimate. Coins other than legitimate ones are ejected from the coin payout opening 19. In addition, the coin counter 21C outputs a signal to the main CPU 41 when detecting the legitimate coin.

The reverter 21S operates based on the control signal from the main CPU 41 and distributes the legitimate coins validated by the coin counter 21C to the cash box (not shown) within the slot machine 10 or to the hopper 66. In other words, when the hopper 66 is filled with coins, the legitimate coins are distributed to the cash box by the reverter 21S. On the other hand, when the hopper 66 is not filled with coins, the legitimate coins are distributed to the hopper 66.

The cold cathode tubes 81 are installed behind the lower display panel 16 and the upper display panel 33, respectively, and function as a backlight. The cold cathode tube 81 lights up based on the control signal from the main CPU 41.

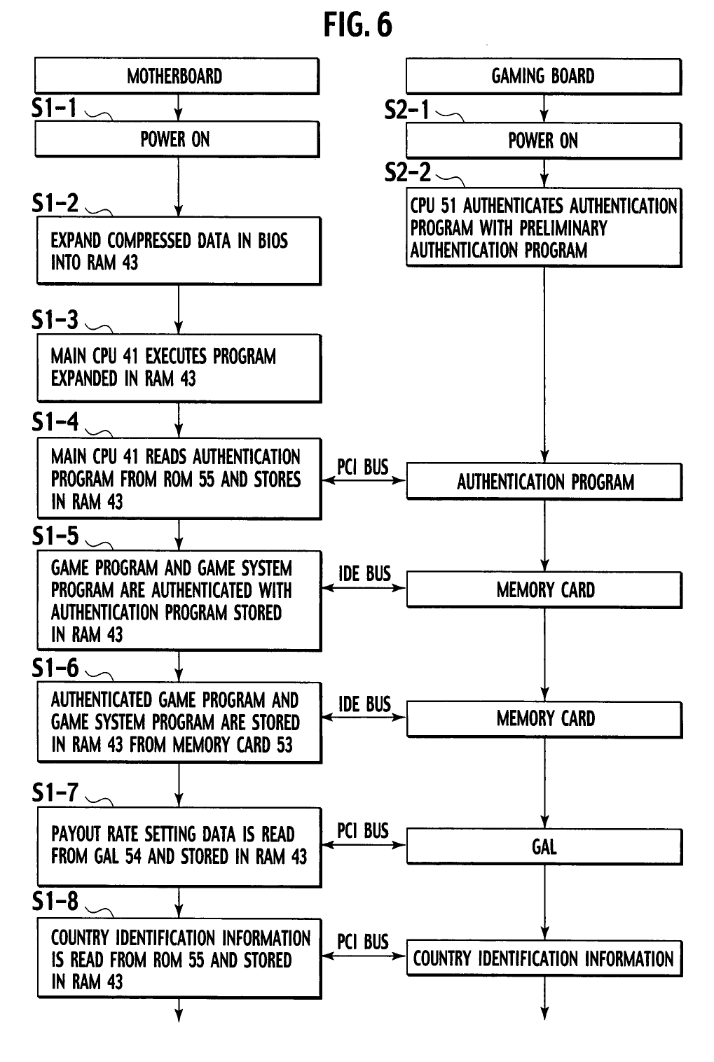

Next, specific processing executed in the slot machine 10 will be described. FIG. 6 is a flow chart showing the procedure of authentication processing (processing in step S100 shown in FIG. 1) of the game program and the game system program by the motherboard 40 and the gaming board 50 shown in FIG. 5. Here, it is assumed that the memory card 53 is inserted into the card slot 53S of the gaming board 50 and the GAL 54 is also inserted into the IC socket 54S.

First, the motherboard 40 and the gaming board 50 are activated when the power switch on the power supply unit 45 is turned on (step S1-1, S2-1). Separate processings are executed parallel on the motherboard 40 and the gaming board 50 after they has been activated. In other words, on the gaming board 50, the CPU 51 reads the preliminary authentication program stored in the boot ROM 52, and executes preliminary authentication to check and prove that the authentication program has not been falsified according to the read preliminary authentication program (step S2-2). The preliminary authentication of the authentication program is executed before the authentication program is taken into the motherboard 40.

On the other hand, on the motherboard 40, the main CPU 41 executes the BIOS stored in the ROM 42, and expands the compressed data incorporated in the BIOS into the RAM 43 (step S1-2). Then, the main CPU 41 executes the BIOS expanded in the RAM 43, and diagnoses and initializes the various peripheral devices (step S1-3).

Then, since the ROM 55 of the gaming board 50 is connected to the main CPU 41 via the PCI bus, the main CPU 41 reads the authentication program stored in the ROM 55. Further, the main CPU 41 executes processing to store the read authentication program in the RAM 43 (step S1-4).

Next, the main CPU 41 accesses the memory card 53 inserted into the card slot 53S via the IDE bus. Then, the main CPU 41 reads the game program and the game system program stored in the memory card 53.

Next, the main CPU 41 executes authentication processing to check and prove that the read game program and game system program have not been falsified according to the authentication program stored in the RAM 43 (step S1-5).

When the authentication processing is completed successfully, the main CPU 41 stores the authenticated game program and game system program in the RAM 43 (step S1-6). Next, the main CPU 41 accesses the GAL 54 inserted into the IC socket 54S via the PCI bus to read the payout rate setting data from the GAL 54, and stores the read payout rate setting data in the RAM 43 (step S1-7). Next, the main CPU 41 reads the country identification information stored in the ROM 55 of the gaming board 50 via the PCI bus, and stores the read country identification information in the RAM 43 (step S1-8).

After the above-described processing, the main CPU 41 reads the game program and the game system program from the RAM 43, and executes the programs to advance the base game described below.

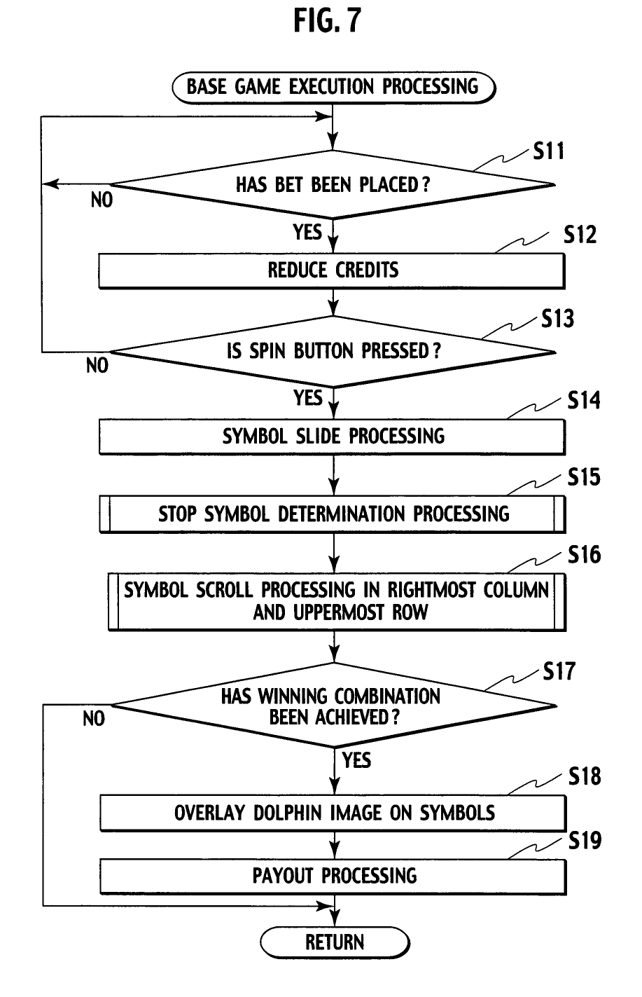

After the authentication processing in FIG. 6 is executed, the main CPU 41 executes the execution processing of the base game. FIG. 7 is a flow chart showing the specific procedure of the base game execution processing shown in step S200 in FIG. 1.

In the base game execution processing, the main CPU 41 firstly determines whether or not a bet has been placed (step S11). In this processing, the main CPU 41 determines whether or not it has received a signal output from the 1-bet switch 26S when the 1-bet button 26 is pressed or a signal output from the max-bet switch 27S when the max-bet button 27 is pressed. When it is determined that the bet has not been placed, the processing returns to step S11.

On the other hand, when it is determined that the bet has been placed, the main CPU 41 executes processing to reduce the credits stored in the RAM 43 in accordance with the bet amount (step S12). If the bet amount is greater than the credits stored in the RAM 43, the credits stored in the RAM 43 is not reduced and the processing returns to step S11. In addition, when the bet amount exceeds the upper limit that can be bet on a single game (50 credits or coins in the present embodiment), the credits stored in the RAM 43 are not reduced and the processing proceeds to step S13.

Next, the main CPU 41 determines whether or not the spin button 23 has been pressed (step S13). Here, the main CPU 41 determines whether or not it has received a signal output from the spin switch 23S when the spin button 23 is pressed.

When it is determined that the spin button 23 has not been pressed (NO in step S13), the processing returns to step S11. When the spin button 23 has not been pressed (for example, a game ending direction is input by the player instead of pressing the spin button 23), the main CPU 41 cancels the operation of reduction in step S12.

In the present embodiment, the credits are reduced (step S12) after a bet has been placed (YES in step S11) and before whether or not the spin button 23 has been pressed is determined (step S13). However, the present invention is not limited to this example. For example, whether or not the spin button 23 has been pressed may be determined (step S13) just after the affirmative judgment of placing a bet (YES in step S11), and then the credits may be reduced (step S12) if it is determined that the spin button 23 has been pressed (YES in step S13).

On the other hand, when it is determined that the spin button 23 has been pressed (YES in step S13), the main CPU 41 executes processing to slide the symbols displayed in each of the display areas 28 (28a1 to 28e5) leftward and downward by one (step S14). For example, after the previous base game is completed, the symbols displayed in the display areas 28 (FIG. 10) are slid leftward and downward by one, respectively (FIG. 11).

Next, after the slide of the symbols, the main CPU 41 executes stop symbol determination processing to determine symbols to be stopped in each of the display areas 28 in the rightmost column and the uppermost row (step S15). In this stop symbol determination processing, the main CPU 41 determines symbols to be stopped in each of the nine display areas 28 (28e1 to 28e5, 28a1 to 28e1) in the rightmost column and the uppermost row by executing the stop symbol determination program stored in the RAM 43. The detail of the stop symbol determination processing is described later.

Next, the main CPU 41 executes the scroll processing to scroll the symbols in each of the nine display areas 28 (28e1 to 28e5, 28a1 to 28e1) in the rightmost column and the uppermost row (step S16). In this processing, the scroll of symbols is started in each of the nine display areas 28, and then, the symbols previously determined in step S15 are stopped in each of the nine display areas 28. The symbol scroll processing is described later in detail.

After this, the main CPU 41 determines whether or not a winning combination has been achieved (step S17). One example of winning combinations is that the three “diamond” symbols are arranged successively on a straight line as shown in FIG. 4.

Then, when it is determined that a winning combination has been achieved (YES in step S17), the dolphin image (for example, animated jumping dolphin) is overlaid on (or near) each of the symbols constituting the winning combination (for example, three “diamond”) in order to notice the player that a winning combination has been achieved (step S18; refer to FIG. 12).

After this, the main CPU 41 refers to the payout table in FIG. 4 and provides a payout (step S19). For example, when the three “diamond” symbols have stopped successively on a straight line, a payout of five coins is provided. The base game is executed as described above.

In the above-described base game, after the spin button 23 is pressed, the symbols displayed in the display areas 28 are slid leftward and downward by one and then the symbols are scrolled in each of the display areas 28 (28e1 to 28e5, 28a1 to 28e1) in the rightmost column and the uppermost row. However, it may also be possible to slide the symbols displayed in the display areas 28 rightward and upward by one and then scroll the symbols in each of the display areas 28 in the leftmost column and the lowermost row.

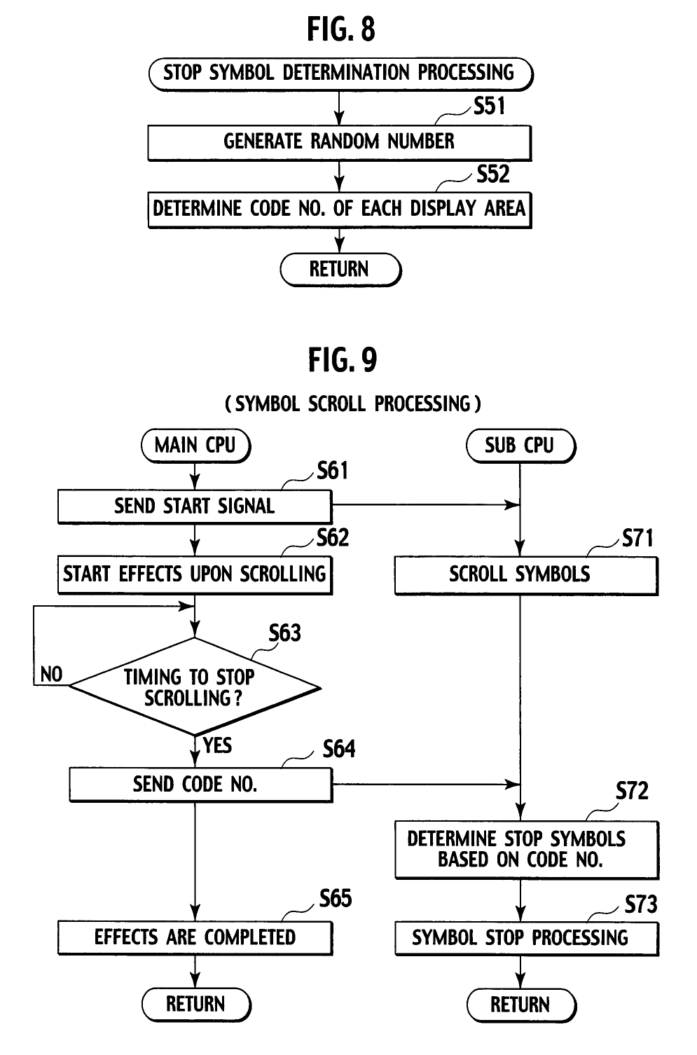

Next, the stop symbol determination processing in step S15 in FIG. 7 will be described with reference to flow chart shown in FIG. 8.

The stop symbol determination processing is executed by executing the stop symbol determination program stored in the RAM 43 by the main CPU 41.

First, the main CPU 41 executes a random number generation program included in the stop symbol determination program, and generates random numbers within the range 0 to 255. The generated random numbers correspond to the respective display areas 28 (28e1 to 28e5, 28a1 to 28e1) in the rightmost column and the uppermost row (step S51).

Next, the main CPU 41 refers to the weighting data in accordance with the payout rate setting data, which is output from the GAL 54 and stored in the RAM 43. And the main CPU 41 determines code numbers (refer to FIG. 3) corresponding to the respective display areas 28 based on the generated random numbers (step S52).

FIG. 9 is a flow chart showing the symbol scroll processing shown in step S16 in FIG. 7. This processing is cooperatively executed by the main CPU 41 and the sub CPU 61.

First, the main CPU 41 sends a start signal to the CPU 61. The start signal is a signal to command start of the symbol scroll in each of the display areas 28 (28e1 to 28e5, 28a1 to 28e1) in the rightmost column and the uppermost row (step S61). The sub CPU 61 outputs a symbol scroll command to the VDP 46 when receiving the start signal from the main CPU 41. The VDP 46 reads symbol image data from the image data ROM 47 and scrolls the symbols in each of the display areas 28 (28e1 to 28e5, 28a1 to 28e1) in the rightmost column and the uppermost row (step S71). In this manner, the symbol scroll is started in each of the nine display areas 28 in the rightmost column and the uppermost row.

After sending the start signal to the sub CPU 61 in step S61 in FIG. 9, the main CPU 41 produces the effects upon symbol scrolling (step S62). In this processing, image display effects on the lower display panel 16, audio effects by the speakers 29, etc., are produced over the period (for example, three seconds) specified in accordance with the result etc. of the stop symbol determination processing (step S15 in FIG. 7).

Next, the main CPU 41 determines whether or not it is a timing to stop scrolling (step S63 in FIG. 9).

When it is determined not to be the timing to stop scrolling (NO in step S63), the processing returns to step S63 and the effects upon scrolling are continued. On the other hand, when it is determined to be the timing to stop scrolling (YES in step S63), the main CPU 41 sends the code numbers of the symbols stored in the RAM 43 to the sub CPU 61 (step S64). The sub CPU 61 determines the stop symbols corresponding to the code numbers when receiving the code numbers from the main CPU 41 (step S72).

After this, the scroll stop processing is executed and the symbols are stopped in each of the display areas 28 (step S73). In addition, the display processing of effect images by the CPU 41 is completed (step S65).

Next, a display example of the LCD 17 is described with reference to FIGS. 10 to 13. FIG. 10 is a display example before the base game is started. The symbols, which have been stopped in the previous base game, are still displayed. At this time, the swimming dolphin image is overlaid on each of the display areas 28d1 to 28d5 in the second column from the right.

FIG. 11 is a display example when the base game is started. After the base game is started, the symbols displayed in the display areas 28 (28a1 to 28e5) are slid leftward and downward by one (step S14 in FIG. 7). Accompanying this, the scroll of the symbols is started in each of the nine display areas 28 (28e1 to 28e5, 28a1 to 28e1) in the rightmost column and the uppermost row (step S16 in FIG. 7).

FIG. 12 is a display example when the symbols stopped in the nine display areas 28 in the rightmost column and the uppermost row. As a result of the “diamond” symbol stopped in the display area 28e2 (in the second row from the top in the rightmost column), a winning combination (the three successive “diamond” symbols lie obliquely) has been achieved. In other words, the “diamond” symbols have stopped in the three display areas 28c4, 28d3, and 28e2, and a payout of five coins per one bet will be awarded. In addition, the jumping dolphin images are overlaid on the “diamond” symbols in order to notice the player that the winning combination has been achieved, and thereby the player's attention is drawn.

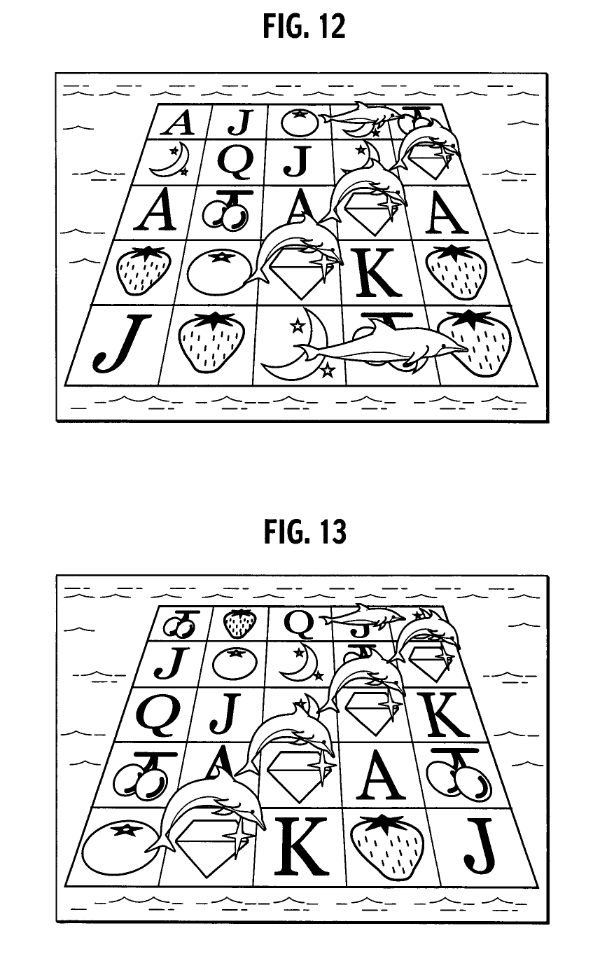

FIG. 13 shows a state in which the “diamond” symbol is displayed in the display area 28e2 in the rightmost column in the next base game. In this case, one more “diamond” symbol is added to the three successive “diamond” symbols arranged obliquely in the above-described FIG. 12. As a result, a winning combination of the four successive “diamond” symbols is achieved. In this case, a payout of 10 coins per one bet is awarded (refer to FIG. 4). Further, the dolphins jump over the four “diamond” symbols to draw the player's attention.

As described above, with the slot machine in the present embodiment, after the each base game is started, the symbols displayed in the 5 columns×5 rows display areas 28 are slid leftward and downward by one. Further, the scroll of the symbols is started in the display areas 28 (28e1 to 28e5, 28a1 to 28e1) in the rightmost column and the uppermost column after the slide of the symbols, and then they are stopped. As to the resultant combination of symbols, it is determined whether or not a winning combination is achieved. Then, a payout is provided to the player according to a winning combination if the winning combination has been achieved.

In other words, the symbols having stopped in the previous base game are slid leftward and downward by one. And then, the symbols are newly scrolled in the display areas which have become blanked after the slide of the symbols, and then the symbols are stopped. By displaying symbols in such an extremely innovative style, it is possible to provide a player with a high entertainment feature with which the player is unlikely to become boring.

In addition, when a winning combination has been achieved, the attention-grabber images (animated images which shows jumping dolphins over (or near) the symbols constituting the winning combination) are displayed in order to notify the player that the winning combination has been achieved. Consequently, the player can have a stronger feeling of expectation for payout.

Further, the payout amount when four identical symbols are displayed successively on a straight line is greater than that when three are displayed successively. Therefore, the player can have a feeling of expectation that a winning combination, which causes a larger payout than the previous base game, may be achieved in the next base game. Due to this, the player can have a stronger feeling of expectation for successive payouts.

As above, the embodiments of the slot machine of the present invention are described, however, they are only specific examples, not limiting the present invention in particular. The specific configuration of units can be modified in design appropriately. Further, the effects described in the embodiments of the present invention are only selected and enumerated from among the most preferred effects obtained from the present invention. The effects of the present invention are not limited to those described in the embodiments of the present invention.

For example, in the above-described embodiments, the symbols displayed in the 5 columns×5 rows display areas 28 (28a1 to 28e5) are slid leftward and downward by one. However, they may be slid by two or more.

In a first aspect of the present invention, when a plurality of symbols is rearranged in each of the display areas in the current unit game, the symbols, which have been displayed in the display areas except for at least one row and at least one column among the plurality of display areas, are moved into other display areas and the moved symbols are held in the other display areas. And then, in each of the display areas other than those (each of the display areas in which the moved symbols are not held), symbols are rearranged respectively (in the above-mentioned embodiments, symbols are scrolled and then stopped in each of the display areas). In the first aspect of the present invention, symbols are rearranged in such an extremely innovative style as described above. Then, with the symbols displayed from the previous unit game (=the symbols only moved in the current unit game) and the symbols newly rearranged (=the symbols scrolled and then stopped) in the current unit game, (i) if a winning combination is achieved or (ii) if a prescribed number of specific symbols are rearranged, a prescribed payout is provided to the player. In addition, if the symbols, which can meet the above conditions (i) or (ii), still remains (only moved) in the current game, there is the possibility that a further payout will be expected depending on newly rearranged symbols. Consequently, the player can have a stronger feeling of expectation for payout because of the extremely innovative style of displaying symbols.

In a second aspect of the present invention, in addition to the above-described first aspect, (i) the greater the number of symbols constituting the specific combination or (ii) the greater the number of the specific symbols, the more payout amount is provided to the player. For example, if the symbols arranged in the previous unit game still remains (only moved), the possibility of satisfying the above conditions (i) or (ii) may increase. Consequently, the player can have a stronger feeling of expectation for payout because of the extremely innovative style of displaying symbols. Furthermore, if the payout has been awarded in the previous unit game and the symbols which causes the payout remains (only moved) in the current game, the player can have a stronger feeling of expectation for larger payout.

In a third aspect of the present invention, when a plurality of symbols is rearranged in each of the display areas in the current unit game, the symbols, which have been displayed in the display areas except for one outer-most row and one outer-most column among the plurality of display areas, are moved into other display areas and the moved symbols are held in the other display areas. And then, in each of the display areas other than those (each of the display areas in which the moved symbols are not held), symbols are rearranged respectively (in the above-mentioned embodiments, symbols are scrolled and then stopped in each of the display areas). In the third aspect of the present invention, symbols are rearranged in such an extremely innovative style as described above. Then, with the symbols displayed from the previous unit game (=the symbols only moved in the current unit game) and the symbols newly rearranged (=the symbols scrolled and then stopped) in the current unit game, (i) if a winning combination is achieved or (ii) if a prescribed number of specific symbols are rearranged, a prescribed payout is provided to the player. In addition, if the symbols, which can meet the above conditions (i) or (ii), still remains (only moved) in the current game, there is the possibility that a further payout will be expected depending on newly rearranged symbols. Consequently, the player can have a stronger feeling of expectation for payout because of the extremely innovative style of displaying symbols.

In a fourth aspect of the present invention, when a plurality of symbols is rearranged in each of the display areas in the current unit game, the symbols, which have been displayed after the previous unit game in the display areas except for at least one row and at least one column among the plurality of display areas, are moved into other display areas and the moved symbols are held in the other display areas. And then, in each of the display areas other than those (each of the display areas in which the moved symbols are not held), symbols are rearranged respectively (in the above-mentioned embodiments, symbols are scrolled and then stopped in each of the display areas). In the fourth aspect of the present invention, symbols are rearranged in such an extremely innovative style as described above. Then, with the symbols displayed from the previous unit game (=the symbols only moved in the current unit game) and the symbols newly rearranged (=the symbols scrolled and then stopped) in the current unit game, (i) if a winning combination is achieved or (ii) if a prescribed number of specific symbols are rearranged, a prescribed payout is provided to the player. In addition, if the symbols, which can meet the above conditions (i) or (ii), still remains (only moved) in the current game, there is the possibility that a further payout will be expected depending on newly rearranged symbols. Consequently, the player can have a stronger feeling of expectation for payout because of the extremely innovative style of displaying symbols.

In a fifth aspect of the present invention, in addition to the above-described fourth aspect, (i) the greater the number of symbols constituting the specific combination or (ii) the greater the number of the specific symbols, the more payout amount is provided to the player. For example, if the symbols arranged in the previous unit game still remains (only moved), the possibility of satisfying the above conditions (i) or (ii) may increase. Consequently, the player can have a stronger feeling of expectation for payout because of the extremely innovative style of displaying symbols. Furthermore, if the payout has been awarded in the previous unit game and the symbols which causes the payout remains (only moved) in the current game, the player can have a stronger feeling of expectation for larger payout.

In a sixth aspect of the present invention, in addition to the above-described fifth aspect, if the above conditions (i) or (ii) meet, an image for drawing the player's attention is displayed near the symbols, which cause the satisfactory of the conditions (i) or (ii). Consequently, the player can have a stronger feeling of expectation for payout because of the extremely innovative style of displaying symbols and displaying the image for drawing player's attention.

What is claimed is:

1. A slot machine comprising:
a display which has a plurality of display areas in a plural rows by plural columns matrix, and on which symbols are arranged and rearranged in each of the display areas in each unit game; and
a controller operable to:
(a) move the symbols, which have been displayed in the display areas except for at least one row and at least one column among the plurality of display areas, into other display areas after a unit game is started and hold the moved symbols in the other display areas;
(b) rearrange the symbols in each of the display areas, in which the moved symbols are not held; and
(c) provide a payout to a player (i) when a specific combination is achieved with the moved symbols and the rearranged symbols or (ii) when a prescribed number of specific symbols are displayed among the moved symbols and the rearranged symbols.

2. The slot machine according to claim 1, wherein
the controller is operable to provide the payout of (c) in the current unit game, even if the payout of (c) has been provided in the previous unit game.

3. The slot machine according to claim 2, wherein
(i) the greater the number of symbols constituting the specific combination or (ii) the greater the number of the specific symbols, the more payout amount is provided to the player.

4. The slot machine according to claim 1, wherein
the controller is operable to display an image for drawing the player's attention respectively near (i) the symbols constituting the specific combination or (ii) the prescribed number of specific symbols.

5. The slot machine according to claim 4, wherein
the image for drawing the player's attention is overlaid on the respective symbols.

6. A slot machine comprising:
a display which has a plurality of display areas in a plural rows by plural columns matrix, and on which symbols are arranged and rearranged in each of the display areas in each unit game; and
a controller operable to:
(a) move the symbols, which have been displayed in the display areas except for at least one row and at least one column among the plurality of display areas, into other display areas after a unit game is started and hold the moved symbols in the other display areas;
(b) rearrange the symbols in each of the display areas, in which the moved symbols are not held; and
(c) provide a payout to a player (i) when a specific combination is achieved with the moved symbols and the rearranged symbols or (ii) when a prescribed number of specific symbols are displayed among the moved symbols and the rearranged symbols,
wherein (i) the greater the number of symbols constituting the specific combination or (ii) the greater the number of the specific symbols, the more payout amount is provided to the player.

7. The slot machine according to claim 6, wherein
the controller is operable to display an image for drawing the player's attention respectively near (i) the symbols constituting the specific combination or (ii) the prescribed number of specific symbols.

8. A slot machine comprising:
a display which has a plurality of display areas in a plural rows by plural columns matrix, and on which symbols are arranged and rearranged in each of the display areas in each unit game; and
a controller operable to:
(a) move the symbols, which have been displayed in the display areas except for one outer-most row and one outer-most column among the plurality of display areas, into other display areas after a unit game is started and hold the moved symbols in the other display areas;
(b) rearrange the symbols in each of the display areas, in which the moved symbols are not held; and
(c) provide a payout to a player (i) when a specific combination is achieved with the moved symbols and the rearranged symbols or (ii) when a prescribed number of specific symbols are displayed among the moved symbols and the rearranged symbols.

9. The slot machine according to claim 8, wherein
the controller is operable to provide the payout of (c) in the current unit game, even if the payout of (c) has been provided in the previous unit game.

10. The slot machine according to claim 9, wherein
(i) the greater the number of symbols constituting the specific combination or (ii) the greater the number of the specific symbols, the more payout amount is provided to the player.

11. The slot machine according to claim 8, wherein
the controller is operable to display an image for drawing the player's attention respectively near (i) the symbols constituting the specific combination or (ii) the prescribed number of specific symbols.

12. A playing method of a slot machine having a display which has a plurality of display areas in a plural rows by plural columns matrix, comprising:
moving symbols, which have been displayed after a previous unit game in the display areas except for at least one row and at least one column among the plurality of display areas, into other display areas after a current unit game is started and holding the moved symbols in the other display areas;
rearranging symbols in each of the display areas, in which the moved symbols are not held; and
providing a payout to a player (i) when a specific combination is achieved with the moved symbols and the rearranged symbols or (ii) when a prescribed number of specific symbols are displayed among the moved symbols and the rearranged symbols.

13. The playing method according to claim 12, wherein
(i) the greater the number of symbols constituting the specific combination or (ii) the greater the number of the specific symbols, the more payout amount is provided to the player.

14. The playing method according to claim 12, further comprising:
displaying an image for drawing the player's attention respectively near (i) the symbols constituting the specific combination or (ii) the prescribed number of specific symbols.

15. The playing method according to claim 14, wherein
the image for drawing player's attention is overlaid on the respective symbols.

16. A playing method of a slot machine having a display which has a plurality of display areas in a plural rows by plural columns matrix, comprising:
moving symbols, which have been displayed after a previous unit game in the display areas except for at least one row and at least one column among the plurality of display areas, into other display areas after a current unit game is started and holding the moved symbols in the other display areas;
rearranging symbols in each of the display areas, in which the moved symbols are not held; and
providing a payout to a player (i) when a specific combination is achieved with the moved symbols and the rearranged symbols or (ii) when a prescribed number of specific symbols are displayed among the moved symbols and the rearranged symbols,
wherein (i) the greater the number of symbols constituting the specific combination or (ii) the greater the number of the specific symbols, the more payout amount is provided to the player.

17. The playing method according to claim 16, further comprising:
displaying an image for drawing the player's attention respectively near (i) the symbols constituting the specific combination or (ii) the prescribed number of specific symbols.

18. The playing method according to claim 17, wherein
the image for drawing the player's attention is overlaid on the respective symbols.

19. A playing method of a slot machine having a display which has a plurality of display areas in a plural rows by plural columns matrix, comprising:
moving symbols, which have been displayed after a previous unit game in the display areas except for at least one row and at least one column among the plurality of display areas, into other display areas after a current unit game is started and holding the moved symbols in the other display areas;
rearranging symbols in each of the display areas, in which the moved symbols are not held;
displaying an image for drawing the player's attention respectively near (i) the symbols constituting the specific combination or (ii) the prescribed number of specific symbols; and
providing a payout to a player (i) when a specific combination is achieved with the moved symbols and the rearranged symbols or (ii) when a prescribed number of specific symbols are displayed among the moved symbols and the rearranged symbols.

20. The playing method according to claim 19, wherein
the image for drawing player's attention is overlaid on the respective symbols.
